(19) United States
(12) Patent Application Publication
(10) Pub. No.: US 2016/0361812 A1
(43) Pub. Date: Dec. 15, 2016

(54) TETHERABLE MULTI TOOL

(71) Applicant: Thomas Carl Cason, IV, Hudson, NH (US)

(72) Inventor: Thomas Carl Cason, IV, Hudson, NH (US)

(21) Appl. No.: 14/737,718

(22) Filed: Jun. 12, 2015

(51) Int. Cl. B25H 3/00; B25F 1/00; B25B 13/06; A45F 5/02; B25B 15/00

(52) U.S. Cl. CPC B25H 3/00; A45F 5/02; B25B 15/007; B25B 13/06; B25F 1/00

(57) ABSTRACT

The invention comprises a tetherable multi tool with an adaptive tethering system for attachment to a user or other secure anchor. The multi tool comprises a first tool that includes a shaft with first and second shaft ends, a second tool having a body with first and second body ends and a tether attachment point. The invention further comprises a tether attachment point affixed to the body and a tether having a first tether coupling that engages with the tether attachment point and/or an anchor point.

### GOVERNMENT SUPPORT

No government support was received. The government has no rights in the invention.

### BACKGROUND OF THE INVENTION

A hand tool may be equipped with a tether to prevent the tool from being lost or misplaced, to prevent the tool from causing damage or injury if it is dropped, or merely to increase the utility of a hand tool by making it portable and readily available for frequent use. A tether coupled to a hand tool may be attached to an article of clothing, belt, strap, or band worn by a person using the tool, or the tether may be attached to another secure anchor such as a scaffold, work bench, or part of a vehicle.

Tools comprising tethers are known in the art. Tools with retractable tethers, such as that found in U.S. Pat. No. 13/097,929 (Cornell et al.) show a tether extension/retraction mechanism built into the body of the tool. Tools wherein the extension/retraction mechanism is attached to the user and the tether attached to the tool are also known. In the case of multi tools such as that of Cornell et al., the tools contained within the handle are designed to rotate about the longitudinal axis of the handle, in-line with the extend/retract axis of the tether. They do not provide for the tools within the body rotating about different axes during use. In other words, the range of motion of the tool is limited by the axis used. Tools wherein the extension/retraction mechanism is attached to the user suffer from similar limitations regardless of where the tether is attached to the tool.

Woodsmen, loggers and foresters routinely operate chainsaws for extended periods while performing their jobs. Any of the permanently tethered embodiments previously discussed are unsuitable for these users. To remain safe and efficient during operation, chainsaws require frequent adjustments and maintenance involving various tools. Chainsaw chains and bars often require both a socket wrench and a screwdriver for tensioning. A chainsaw engine sparkplug is prone to fouling due to the fuel mixture and amount of dust taken into the cylinder during normal operation. Sparkplug removal and replacement often requires a socket wrench sized differently than that used for chain and bar adjustment. During maintenance, a full range of motion is needed for efficiency which is not possible when the tool is tethered.

Chainsaws, are frequently carried by hand to remote off-road locations and to significant heights when topping trees or removing dead and dangerous limbs. In both locations, regular chainsaw maintenance as previously discussed is performed in-place whether the operator is on the ground or high up in a tree. The tools necessary for maintenance are carried with them and preferably tethered to the user to free up their hands when not in use and fully untethered when in use. A logger in a tree may wish to tether the tool or tools to a branch for convenience whereas a forester on the ground may wish to tether the tool to a vehicle or other secure anchor. A multi tool incorporating the various tools needed for routine chainsaw maintenance and which provides an easily removable tether that is adaptable for use on various secure anchors is therefore desirable.

### SUMMARY OF THE INVENTION

The invention comprises a tetherable multi tool with an adaptive tethering system for attachment to a user or other secure anchor. The multi tool comprises a first tool that includes a shaft with first and second shaft ends, a second tool having a body with first and second body ends and a tether attachment point. Two axes are defined, one defined by a line extending centrally and longitudinally through the shaft and beyond the first and second shaft ends and the other defined by a line extending centrally and longitudinally through the body and beyond the first and second body ends. The invention further comprises a tether attachment point affixed to the body and a tether having a first tether coupling that engages with the tether attachment point and/or an anchor point. The first shaft end of the first tool is affixed to the body of the second tool such that the axis of the first tool intersects the axis of the second tool at about a 90 degree angle and the tether attachment point is affixed to the body of the second tool.

The tether attachment point may be pivotally coupled to the body of the second tool. This allows the tool to freely rotate with respect to the tether. The tether coupling may also pivotally engage with the tether attachment point to achieve the same effect.

The tether may comprise a second tether coupling that engages with an anchor point. Examples of anchor points may include the user's belt or belt loop, vehicles, tree branches, buildings, etc. The second tether coupling can also be configured so that it pivotally engages with an anchor point.

The tether attachment point may comprise an aperture. A simple attachment point such as an aperture allows for a variety of tether couplings and is easy to place and affix on the body during manufacture.

The second shaft end of the multi tool may terminate in a flathead screwdriver. Other terminations are also considered, such as a cross or Philips head screwdriver, a torx head or a nut driver.

The first body end of the multi tool is configured to engage with a first fastener. Configurations may comprise a shaped socket or open-end wrench. The second body end is configured to engage with a second fastener. The first and second fastener ends are contemplated to be of different sizes.

The tether attachment point and the first shaft end may be attached approximately at the midpoint of the body on opposing sides of the body. The placement of the tether attachment point may vary as it is an object of the invention to have the multi tool substantially weight balanced when suspended by the tether attachment. Generally, the first tool and second tool form a tee configuration which also aids in the weight distribution and balance.

Overall, the summary descriptions or combinations thereof provide for a multi tool ideally adapted to service a chainsaw.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an overhead drawing of one embodiment which displays the major elements thereof.

FIG. 2 is a detail drawing showing embodiment variations in the tether and tether attachment point.

### DETAILED DESCRIPTION OF THE INVENTION

A description of preferred embodiments of the invention follows.

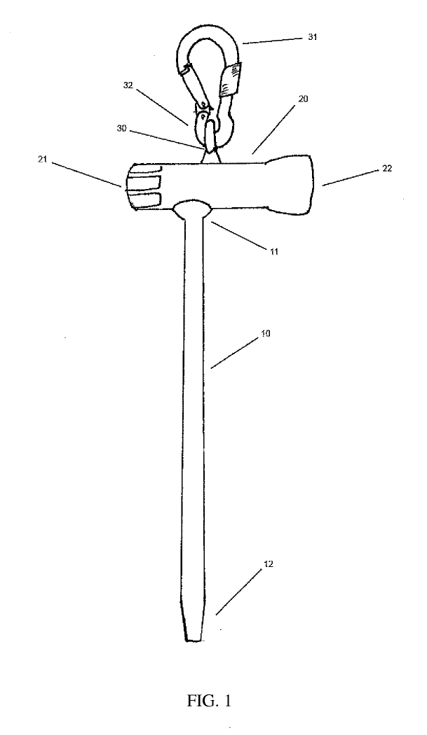

As shown in FIG. 1, a preferred embodiment of the tetherable multi tool comprises: a first tool having a shaft 10, a first shaft end 11, and a second shaft end 12; a second tool having a body 20, a first body end 21, and a second body end 22; a tether attachment point 30; and a tether 31 having a first tether coupling 32 that engages with the tether attachment point 30 and/or an anchor point. The first tool features an axis 13 defined by a line extending centrally and longitudinally through the shaft 10 and beyond the first shaft end 11 and the second shaft end 12. The second tool features an axis 23 defined by a line extending centrally and longitudinally through the body 20 and beyond the first body end 21 and the second body end 22. The first shaft end 11 of the first tool is affixed to the body 20 of the second tool such that the axis 13 of the first tool intersects the axis 23 of the second tool at about a 90 degree angle and the tether attachment point 31 is affixed to the body 20 of the second tool.

In another embodiment, the tether attachment point 30 is pivotally coupled to the body 20 of the second tool. This configuration allows the multi tool to pivot freely with respect to the tether attachment point 30.

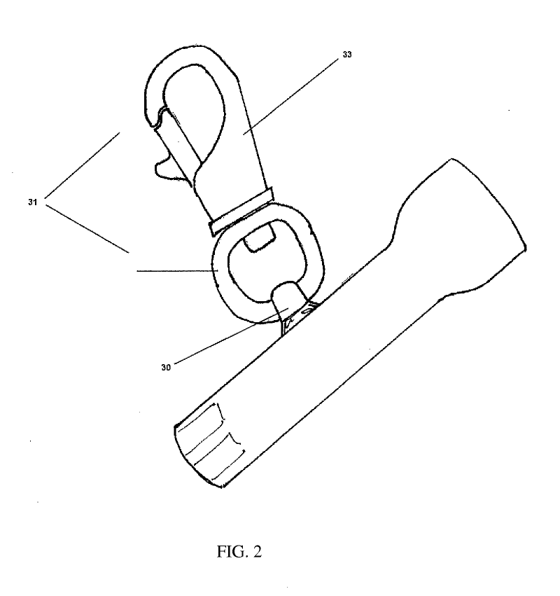

In yet another embodiment as shown in FIG. 2, the tether 31 further comprises a second tether coupling 33 that engages with an anchor point. The second tether coupling may comprise features such as a quick release mechanism, a snap hook, or any other feature specifically suited for a specific type of anchor point.

In still another embodiment shown in FIG. 2, the first tether coupling 32 pivotally engages with the tether attachment point 30. This configuration allows the multi tool to pivot freely with respect to the first tether coupling 32.

In another embodiment, the second tether coupling 33 pivotally engages with an anchor point. This configuration allows the multi tool to pivot freely with respect to the first tether coupling 32, the second tether coupling 33 and the anchor point.

In yet another embodiment, the tether attachment point 30 comprises an aperture. An aperture is simple, inherently flexible and allows for a wide variety of couplings, such as carabiner clips, snap hooks, and the like.

In another preferred embodiment as shown in FIG. 1, the second shaft end 12 terminates in a flathead screwdriver. Other embodiments might comprise the second shaft end 12 terminating in a Philips screwdriver, a torx driver, or the like.

In another embodiment, the first body end 21 is configured to engage with a first fastener. Examples include but are not limited to the first body end 21 configured as a socket to engage with nuts and bolts typically found on a chainsaw or other machinery with similar fasteners, or a specialty fastener if the multi tool is made for a specific piece of equipment.

In yet another embodiment, the second body end 22 is configured to engage with a second fastener. As in the examples of the first body end 21, the second body end 22 may also be configured as a socket to engage with nuts and bolts typically found on a chainsaw or other machinery with similar fasteners, or a specialty fastener if the multi tool is made for a specific piece of equipment.

In still another embodiment, the first fastener and second fastener are of different sizes. Examples include but are not limited to the first body end 21 being configured to engage chainsaw bar retention nuts while the second body end 22 is configured to engage a chainsaw engine spark plug.

In another embodiment, the tether attachment point 30 and the first shaft end 11 are attached approximately at the midpoint of the body 20 and on opposing sides of the body 20.

In a preferred embodiment, the first tool and second tool form a tee configuration.

In another embodiment, the multi tool is substantially weight balanced when suspended by the tether 31. As the tool is typically not in use when tethered and possibly being carried by the user, weight balance is desirable to avoid excessive swinging when the user is in motion.

In any of the previously described embodiments, the multi tool is adapted to be used to service a chainsaw.

While this invention has been particularly shown and described with references to preferred embodiments thereof, it will be understood by those skilled in the art that various changes in form and details may be made therein without departing from the scope of the invention encompassed by the appended claims.

1. A multi tool comprising:
a first tool having a shaft, a first shaft end, a second shaft end and an axis defined by line extending centrally and longitudinally through the first shaft and beyond the first shaft end and the second shaft end;
a second tool having a body, a first body end, a second body end and an axis defined by a line extending centrally and longitudinally through the body and beyond the first body end and the second body end;
a tether attachment point;
a tether having a first tether coupling that engages with the tether attachment point and/or an anchor point; and
wherein the first shaft end of the first tool is affixed to the body of the second tool such that the axis of the first tool intersects the axis of the second tool at about a 90 degree angle and the tether attachment point is affixed to the body of the second tool.

2. The hand tool of claim 1, wherein the tether attachment point is pivotally coupled to the body of the second tool.

3. The hand tool of claim 1, wherein the tether further comprises a second tether coupling that engages with an anchor point.

4. The hand tool of claim 1, wherein the first tether coupling pivotally engages with the tether attachment point.

5. The hand tool of claim 1, wherein the second tether coupling pivotally engages with an anchor point.

6. The hand tool of claim 1, wherein the tether attachment point comprises an aperture.

7. The hand tool of claim 1, wherein the second shaft end terminates in a flathead screwdriver.

8. The hand tool of claim 7, wherein the first body end is configured to engage with a first fastener.

9. The hand tool of claim 8, wherein the second body end is configured to engage with a second fastener.

10. The hand tool of claim 9, wherein the first fastener and second fastener are of different sizes.

11. The hand tool of claim 1, wherein the tether attachment point and the first shaft end are attached approximately at the midpoint of the body and on opposing sides of the body.

12. The hand tool of claim 11, wherein the first tool and second tool form a tee configuration.

13. The hand tool of claim 12, wherein the tool is substantially weight balanced when the hand tool is suspended by the tether.

14. (canceled)
